(19) United States
(12) Patent Application Publication
(10) Pub. No.: US 2025/0272957 A1
(43) Pub. Date: Aug. 28, 2025

(54) SURROUNDING SITUATION RECOGNITION DEVICE, SURROUNDING SITUATION RECOGNITION METHOD, AND NON-TRANSITORY RECORDING MEDIUM

(71) Applicant: TOYOTA JIDOSHA KABUSHIKI KAISHA, Toyota-shi Aichi-ken (JP)

(72) Inventor: Masamichi Ohsugi, Sunto-gun Shizuoka-ken (JP)

(73) Assignee: TOYOTA JIDOSHA KABUSHIKI KAISHA, Toyota-shi Aichi-ken (JP)

(21) Appl. No.: 19/062,694

(22) Filed: Feb. 25, 2025

(30) Foreign Application Priority Data
Feb. 28, 2024 (JP) 2024-028267

(51) Int. Cl. G06V 10/764; B60W 50/14

(52) U.S. Cl. CPC G06V 10/764; B60W 50/14

(57) ABSTRACT

A surrounding situation recognition device determines whether an object mounted on a surrounding vehicle located in the vicinity of a host vehicle corresponds to a specific object which is an object where the number of cases processed in the past as a falling object on a road is greater than or equal to a threshold value, and determines whether an object likely to fall from the surrounding vehicle to the vicinity of the host vehicle exists based on the result of determination whether the object mounted on the surrounding vehicle corresponds to the specific object.

### CROSS-REFERENCE TO RELATED APPLICATIONS

This application claims priority to Japanese Patent Application No. 2024-028267 filed Feb. 28, 2024, the entire contents of which are herein incorporated by reference.

### FIELD

The present disclosure relates to surrounding situation recognition device, surrounding situation recognition method, and non-transitory recording medium.

### BACKGROUND

PTL 1 (JP-A-2021-002410) discloses a technique in which a harbinger of a cargo which is loaded on a bed of a preceding vehicle to fall is detected, and occurrence of the cargo falling is alerted. That is, in the technique described in PTL 1, it is necessary to detect the harbinger of the cargo which is loaded on the bed of the preceding vehicle to fall in order that the occurrence of the cargo falling is alerted.

In the technique described in PTL 1, in order to detect the harbinger of the cargo to fall, the cargo is continuously shot at a predetermined interval, and an image at a certain time point is compared with the subsequent image, a change in appearance of the cargo is continuously monitored, and it is determined whether the cargo falls based on the amount of change in appearance of the cargo. That is, in the technique described in PTL 1, it is necessary to perform an image process with a large calculation load in order to detect the harbinger of the cargo which is loaded on the bed of the preceding vehicle to fall.

On the other hand, the statistical results of the number of cases processed in the past as falling objects on roads are compiled by the Ministry of Land, Infrastructure, Transport and Tourism, expressway companies, and the like. Therefore, a technique which can determine whether an object likely to fall to the vicinity of a host vehicle exists by using such statistical result and the like without performing the image process with the large calculation load is desired.

Although conventionally the driving assistance device as described in PTL 1 has been proposed, in the technique proposed conventionally, it is impossible to appropriately determine whether the object likely to fall from a surrounding vehicle to the vicinity of the host vehicle exists.

### SUMMARY

In view of the above-described points, it is an object of the present disclosure to provide surrounding situation recognition device, surrounding situation recognition method, and non-transitory recording medium that can appropriately determine whether the object likely to fall from the surrounding vehicle to the vicinity of the host vehicle exists.

(1) One aspect of the present disclosure is a surrounding situation recognition device including a processor configured to: determine whether an object mounted on a surrounding vehicle located in the vicinity of a host vehicle corresponds to a specific object which is an object where the number of cases processed in the past as a falling object on a road is greater than or equal to a threshold value; and determine whether an object likely to fall from the surrounding vehicle to the vicinity of the host vehicle exists based on the result of determination whether the object mounted on the surrounding vehicle corresponds to the specific object.

(2) In the surrounding situation recognition device of the aspect (1), the processor may be configured to determine whether the object mounted on the surrounding vehicle corresponds to the specific object which is the object where the number of cases processed in the past as the falling object on the road on which the host vehicle and the surrounding vehicle are currently traveling is greater than or equal to the threshold value.

(3) In the surrounding situation recognition device of the aspect (1) or (2), the processor may be configured to determine whether the object mounted on the surrounding vehicle is in a state where the object mounted on the surrounding vehicle can become the falling object, and determine that the object likely to fall from the surrounding vehicle to the vicinity of the host vehicle exists when it is determined that the object mounted on the surrounding vehicle corresponds to the specific object and when it is determined that the object mounted on the surrounding vehicle is in the state where the object mounted on the surrounding vehicle can become the falling object.

(4) Another aspect of the present disclosure is a surrounding situation recognition method including: determining whether an object mounted on a surrounding vehicle located in the vicinity of a host vehicle corresponds to a specific object which is an object where the number of cases processed in the past as a falling object on a road is greater than or equal to a threshold value; and determining whether an object likely to fall from the surrounding vehicle to the vicinity of the host vehicle exists based on the result of determination whether the object mounted on the surrounding vehicle corresponds to the specific object.

(5) Another aspect of the present disclosure is a non-transitory recording medium having recorded thereon a computer program for causing a processor to perform a process including: determining whether an object mounted on a surrounding vehicle located in the vicinity of a host vehicle corresponds to a specific object which is an object where the number of cases processed in the past as a falling object on a road is greater than or equal to a threshold value; and determining whether an object likely to fall from the surrounding vehicle to the vicinity of the host vehicle exists based on the result of determination whether the object mounted on the surrounding vehicle corresponds to the specific object.

According to the present disclosure, it is possible to appropriately determine whether the object likely to fall from the surrounding vehicle to the vicinity of the host vehicle exists.

### BRIEF DESCRIPTION OF DRAWINGS

FIG. 1 is a view showing an example of a host vehicle 1 to which a surrounding situation recognition device 16 of a first embodiment is applied.

FIG. 2 is a flowchart for explaining an example of a process performed by a processor 163 of the surrounding situation recognition device 16 of the first embodiment.

FIG. 3 is a flowchart for explaining an example of the process performed by the processor 163 of the surrounding situation recognition device 16 of a third embodiment.

FIG. 4 is a view showing an example of the host vehicle 1 to which the surrounding situation recognition device 16 of a fourth embodiment is applied.

FIG. 5 is a flowchart for explaining an example of the process performed by a processor 163 of the surrounding situation recognition device 16 of the fourth embodiment.

### DESCRIPTION OF EMBODIMENTS

Below, referring to the drawings, embodiments of surrounding situation recognition device, surrounding situation recognition method, and non-transitory recording medium of the present disclosure will be explained.

### First Embodiment

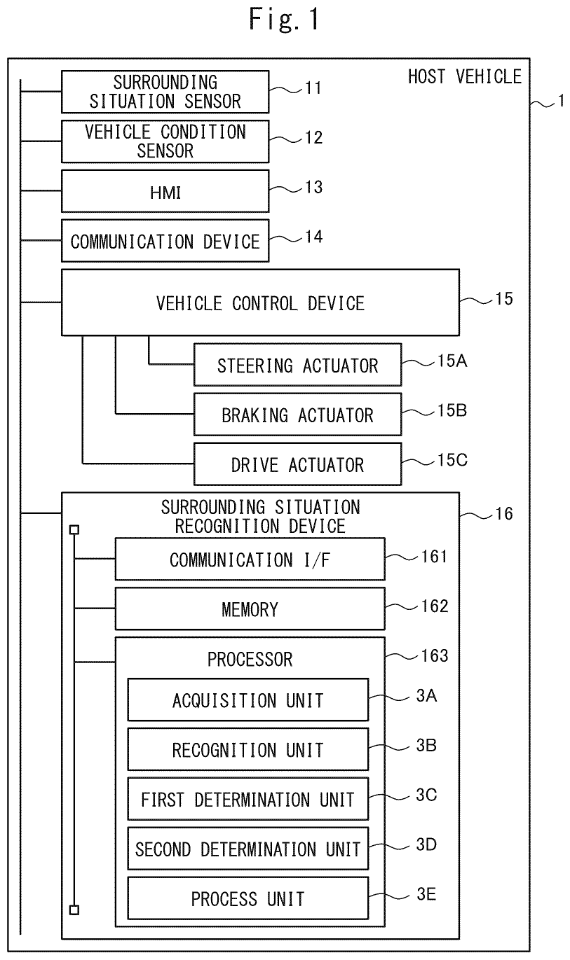

FIG. 1 is a view showing an example of a host vehicle 1 to which a surrounding situation recognition device 16 of a first embodiment is applied.

In the example shown in FIG. 1, the host vehicle 1 includes surrounding situation sensor 11, vehicle condition sensor 12, HMI (Human Machine Interface) 13, communication device 14, vehicle control device 15, steering actuator 15A, braking actuator 15B, drive actuator 15C, and surrounding situation recognition device 16.

The surrounding situation sensor 11 measures a surrounding situation of the host vehicle 1 (for example, a surrounding vehicle located in the vicinity of the host vehicle 1, object mounted on the surrounding vehicle, obstacle located in the vicinity of the host vehicle 1, and the like), and transmits the measurement result of the surrounding situation of the host vehicle 1 to the vehicle control device 15 and the surrounding situation recognizing device 16. The surrounding situation sensor 11 includes, for example, camera, LiDAR (Light Detection And Ranging) or the like.

The vehicle condition sensor 12 measures the condition of the host vehicle 1, and transmits the measurement result of the condition of the host vehicle 1 to the vehicle control device 15. The vehicle condition sensor 12 includes, for example, vehicle speed sensor, acceleration sensor, yaw rate sensor, gyro sensor, and the like.

HMI 13 has the function of receiving various operations of a driver of the host vehicle 1 and the like, and transmits signals indicating the operations of the driver of the host vehicle 1 to the vehicle control device 15.

The communication device 14 communicates with the outside of the host vehicle 1 and transmits the communication result with the outside of the host vehicle 1 to the surrounding situation recognition device 16.

The vehicle control device 15 controls the steering actuator 15A, the braking actuator 15B, and the drive actuator 15C based on information (data, signals) transmitted from, for example, the surrounding situation sensor 11, the vehicle condition sensor 12, and HMI 13.

The surrounding situation recognition device 16 is configured by a microcomputer including communication interface (I/F) 161, memory 162, and processor 163.

The communication interface 161 includes an interface circuit for connecting the surrounding situation recognition device 16 to the surrounding situation sensor 11, the vehicle condition sensor 12, the HMI 13, the communication device 14, and the vehicle control device 15. The memory 162 stores a program used in a process performed by the processor 163 and various data. Specifically, the memory 162 stores, for example, the information on a specific object acquired from the outside of the host vehicle 1 (for example, a WEB site showing the information on the specific object) by the communication device 14, and the like. The specific object is an object where the number of cases processed in the past as a falling object on a road is greater than or equal to a threshold value. The information on the specific object is, for example, ranking information of the falling object.

In the example shown in FIG. 1, the information on the specific object is acquired from the outside of the host vehicle 1 by the communication device 14 and stored in the memory 162, but in another example, the information on the specific object may be stored in the memory 162, for example, at the time of manufacture of the host vehicle 1 or the like (that is, the information on the specific object may not be acquired from the outside of the host vehicle 1 by the communication device 14).

In the example shown in FIG. 1, the processor 163 includes the function as an acquisition unit 3A, the function as a recognition unit 3B, the function as a first determination unit 3C, the function as a second determination unit 3D, and the function as a process unit 3E.

The acquisition unit 3A acquires the measurement result of the surrounding situation sensor 11 from the surrounding situation sensor 11. The measurement result of the surrounding situation sensor 11 includes, for example, an image including the surrounding vehicle and an object mounted on the surrounding vehicle shot by a camera as the surrounding situation sensor 11, the measurement result (e.g., three-dimensional image, etc.) of the surrounding vehicle and the object mounted on the surrounding vehicle by the LiDAR as the surrounding situation sensor 11 and the like. The acquisition unit 3A acquires the information on the specific object from the memory 162.

The recognition unit 3B recognizes the object mounted on the surrounding vehicle located in the vicinity of the host vehicle 1 based on the measurement result of the surrounding situation sensor 11 acquired by the acquisition unit 3A. Specifically, the recognition unit 3B recognizes the object mounted on the surrounding vehicle located in the vicinity of the host vehicle 1 based on the measurement result of the surrounding situation sensor 11 by using a model obtained by performing learning using teacher data which is a data set of, for example, the measurement result of a surrounding situation sensor mounted on a learning vehicle and a label indicating an attribute or the like of an object (learning object) mounted on a surrounding vehicle (learning surrounding vehicle) located in the vicinity of the learning vehicle wherein the vicinity of the learning vehicle is a measurement object of the surrounding situation sensor mounted on the learning vehicle.

The first determination unit 3C determines whether the object mounted on the surrounding vehicle recognized by the recognition unit 3B corresponds to the specific object (object where the number of cases processed in the past as the falling object on the road is greater than or equal to the threshold value). Specifically, the first determination unit 3C determines whether the object mounted on the surrounding vehicle corresponds to the specific object based on the information on the specific object (for example, ranking information or the like of the object where the number of cases processed in the past as the falling object on the road is equal to or more than the threshold value) stored in the memory 162.

The second determination unit 3D determines whether the object likely to fall from the surrounding vehicle to the vicinity of the host vehicle 1 exists based on the determination result of the first determination unit 3C. Specifically, when the first determination unit 3C determines that the object mounted on the surrounding vehicle corresponds to the specific object (object where the number of cases processed in the past as the falling object on the road is greater than or equal to the threshold value), the second determination unit 3D determines that the object likely to fall from the surrounding vehicle to the vicinity of the host vehicle 1 exists. On the other hand, when the first determination unit 3C determines that the object mounted on the surrounding vehicle does not correspond to the specific object, the second determination unit 3D determines that the object likely to fall from the surrounding vehicle to the vicinity of the host vehicle 1 does not exist.

When the second determination unit 3D determines that the object likely to fall from the surrounding vehicle to the vicinity of the host vehicle 1 exists, the process unit 3E performs control for causing the HMI 13 to output a warning indicating that the object likely to fall from the surrounding vehicle to the vicinity of the host vehicle 1 exists.

Therefore, in the example shown in FIG. 1, even when the object falls from the surrounding vehicle to the vicinity of the host vehicle 1, it is possible to suppress the possibility of the collision between the object and the host vehicle 1 or the like. In detail, in the example shown in FIG. 1, it is possible to appropriately determine whether the object likely to fall from the surrounding vehicle to the vicinity of the host vehicle 1 exists by using the information on the specific object without performing an image process with the large calculation load.

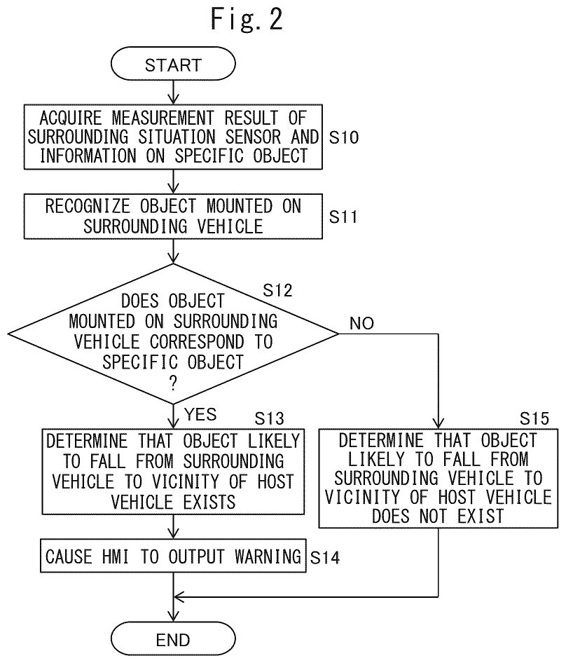

FIG. 2 is a flowchart for explaining an example of a process performed by a processor 163 of the surrounding situation recognition device 16 of the first embodiment.

In the example shown in FIG. 2, at step S10, the acquisition unit 3A acquires the measurement result of the surrounding situation sensor 11 from the surrounding situation sensor 11. The acquisition unit 3A acquires the information on the specific object from the memory 162.

At step S11, the recognition unit 3B recognizes the object mounted on the surrounding vehicle located in the vicinity of the host vehicle 1 based on the measurement result of the surrounding situation sensor 11 acquired at step S10.

At step S12, the first determination unit 3C determines whether the object mounted on the surrounding vehicle recognized at step S11 corresponds to the specific object (object where the number of cases processed in the past as the falling object on the road is greater than or equal to the threshold value) based on the information on the specific object acquired at step S10. When YES, it proceeds to step S13; when NO, it proceeds to step S15.

At step S13, the second determination unit 3D determines that the object likely to fall from the surrounding vehicle to the vicinity of the host vehicle 1 exists.

At step S14, the process unit 3E performs the control for causing the HMI 13 to output the warning indicating that the object likely to fall from the surrounding vehicle to the vicinity of the host vehicle 1 exists.

At step S15, the second determination unit 3D determines that the object likely to fall from the surrounding vehicle to the vicinity of the host vehicle 1 does not exist.

### Second Embodiment

The host vehicle 1 to which the surrounding situation recognition device 16 of a second embodiment is applied is configured similarly to the host vehicle 1 to which the surrounding situation recognition device 16 of the first embodiment described above is applied, except that it will be described later.

In the example shown in FIG. 1 (example of the host vehicle 1 to which the surrounding situation recognition device 16 of the first embodiment is applied), the vehicle control device 15 does not have an autonomous driving function in which the host vehicle 1 is autonomously driven by controlling the steering actuator 15A, the braking actuator 15B, and the drive actuator 15C without the need for operation by the driver of the host vehicle 1.

On the other hand, in an example of the host vehicle 1 to which the surrounding situation recognition device 16 of the second embodiment is applied, the vehicle control device 15 has the autonomous driving function in which the vehicle 1 is autonomously driven by controlling the steering actuator 15A, the braking actuator 15B, and the drive actuator 15C without the need for operation by the driver of the host vehicle 1. Specifically, the vehicle control device 15 generates a travel plan for the host vehicle 1 to reach a destination based on, for example, map information, position information of the host vehicle 1, information indicating the destination of the host vehicle 1, and the like. Furthermore, the vehicle control device 15 causes the host vehicle 1 to travel autonomously according to the travel plan. Specifically, the vehicle control device 15 causes the host vehicle 1 to travel autonomously while correcting the travel plan so as to avoid a collision or the like between the host vehicle 1 and the surrounding vehicle based on the measurement result or the like of the surrounding situation sensor 11.

In the example shown in FIG. 1 (example of the host vehicle 1 to which the surrounding situation recognition device 16 of the first embodiment is applied), as described above, when the second determination unit 3D determines that the object likely to fall from the surrounding vehicle to the vicinity of the host vehicle 1 exists, the process unit 3E performs the control for causing the HMI 13 to output the warning indicating that the object likely to fall from the surrounding vehicle to the vicinity of the host vehicle 1 exists.

On the other hand, in the example of the host vehicle 1 to which the surrounding situation recognition device 16 of the second embodiment is applied, when the second determination unit 3D determines that the object likely to fall from the surrounding vehicle to the vicinity of the host vehicle 1 exists, the process unit 3E causes the vehicle control device 15 to perform correction of the travel plan for allowing the host vehicle 1 to safely travel without the collision between the object and the host vehicle 1 or the like even if the object falls from the surrounding vehicle to the vicinity of the host vehicle 1. The vehicle control device 15 performs correction of the travel plan in accordance with an instruction from the process unit 3E, and causes the host vehicle 1 to travel autonomously according to the corrected travel plan.

Therefore, in the example of the host vehicle 1 to which the surrounding situation recognition device 16 of the second embodiment is applied, even if the object falls from the surrounding vehicle to the vicinity of the host vehicle 1, it is possible to suppress the possibility of the collision between the object and the host vehicle 1 or the like. In detail, it is possible to appropriately determine whether the object likely to fall from the surrounding vehicle to the vicinity of the host vehicle 1 exists by using the information on the specific object without performing the image process with the large calculation load.

### Third Embodiment

The host vehicle 1 to which the surrounding situation recognition device 16 of a third embodiment is applied is configured similarly to the host vehicle 1 to which the surrounding situation recognition device 16 of the first embodiment described above is applied, except that it will be described later.

In the example shown in FIG. 1 (example of the host vehicle 1 to which the surrounding situation recognition device 16 of the first embodiment is applied), as described above, the recognition unit 3B recognizes the object mounted on the surrounding vehicle located in the vicinity of the host vehicle 1 based on the measurement result of the surrounding situation sensor 11 acquired by the acquisition unit 3A, but does not recognize the road on which the host vehicle 1 and the surrounding vehicle are currently traveling.

On the other hand, in an example of the host vehicle 1 to which the surrounding situation recognition device 16 of the third embodiment is applied, the recognition unit 3B recognizes the object mounted on the surrounding vehicle located in the vicinity of the host vehicle 1 based on the measurement result of the surrounding situation sensor 11 acquired by the acquisition unit 3A, and recognizes the road on which the host vehicle 1 and the surrounding vehicle are currently traveling based on the measurement result of the surrounding situation sensor 11 acquired by the acquisition unit 3A.

That is, in the example of the host vehicle 1 to which the surrounding situation recognition device 16 of the third embodiment is applied, the measurement result of the surrounding situation sensor 11 includes the image including the road on which the host vehicle 1 and the surrounding vehicle are currently traveling shot by the camera as the surrounding situation sensor 11, the result (for example, three-dimensional image, etc.) of measurement of the road on which the host vehicle 1 and the surrounding vehicle are currently traveling by the LiDAR as the surrounding situation sensor 11, and the like.

In the example of the host vehicle 1 to which the surrounding situation recognition device 16 of the third embodiment is applied, the recognition unit 3B recognizes the road (for example, the expressway A, the expressway B, etc.) on which the host vehicle 1 and the surrounding vehicle are currently traveling based on the measurement result of the surrounding situation sensor 11 by using the model obtained by performing the learning using the teacher data which is the data set of, for example, the measurement result of the surrounding situation sensor mounted on the learning vehicle and the label indicating the road on which the learning vehicle and the surrounding vehicle (learning surrounding vehicle) located in the vicinity of the learning vehicle wherein the learning vehicle and the surrounding vehicle are included in the measurement result of the surrounding situation sensor mounted on the learning vehicle.

In another example of the host vehicle 1 to which the surrounding situation recognition device 16 of the third embodiment is applied, the acquisition unit 3A may acquire GPS (Global Positioning System) signal and the map information which are used for the recognition of the road on which the host vehicle 1 and surrounding vehicle are currently traveling. In other words, in this example, the recognition unit 3B recognizes the road on which the host vehicle 1 and the surrounding vehicle are currently traveling based on the GPS signal and the map information acquired by the acquisition unit 3A.

In the example of the host vehicle 1 to which the surrounding situation recognition device 16 of the third embodiment is applied, the first determination unit 3C determines whether the object mounted on the surrounding vehicle corresponds to the specific object which is the object where the number of cases processed in the past as the falling object on the road on which the host vehicle 1 and the surrounding vehicle are currently traveling is greater than or equal to the threshold value.

Specifically, the first determination unit 3C determines whether the object mounted on the surrounding vehicle corresponds to the specific object which is the object where the number of cases processed in the past as the falling object on the road on which the host vehicle 1 and the surrounding vehicle are currently traveling is greater than or equal to the threshold value based on the ranking information of the object where the number of cases processed in the past as the falling object on the road (for example, expressway A) on which the host vehicle 1 and the surrounding vehicle are currently traveling is equal to or more than the threshold value among the information on the specific object (for example, ranking information of the object where the number of cases processed in the past as the falling object on the expressway A, ranking information of the object where the number of cases processed in the past as the falling object on the expressway B, and the like) stored in the memory 162.

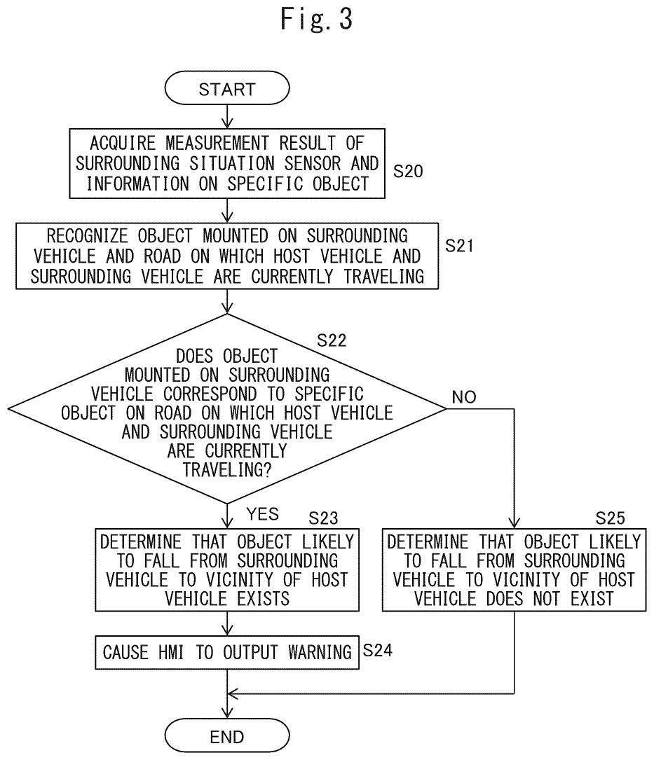

FIG. 3 is a flowchart for explaining an example of the process performed by the processor 163 of the surrounding situation recognition device 16 of a third embodiment.

In the example shown in FIG. 3, at step S20, the acquisition unit 3A acquires the measurement result of the surrounding situation sensor 11 from the surrounding situation sensor 11. The acquisition unit 3A acquires the information on the specific object from the memory 162.

At step S21, the recognition unit 3B recognizes the object mounted on the surrounding vehicle located in the vicinity of the host vehicle 1 based on the measurement result of the surrounding situation sensor 11 acquired at step S20. Further, the recognition unit 3B recognizes the road on which the host vehicle 1 and the surrounding vehicle are currently traveling based on the measurement result of the surrounding situation sensor 11 acquired at step S20.

At step S22, the first determination unit 3C determines whether the object mounted on the surrounding vehicle recognized at step S21 corresponds to the specific object which is the object where the number of cases processed in the past as the falling object on the road on which the host vehicle 1 and the surrounding vehicle are currently traveling is greater than or equal to the threshold value based on the information on the specific object acquired at step S20. When YES, it proceeds to step S23; when NO, it proceeds to step S25.

At step S23, the second determination unit 3D determines that the object likely to fall from the surrounding vehicle to the vicinity of the host vehicle 1 exists.

At step S24, the process unit 3E performs the control for causing the HMI 13 to output the warning indicating that the object likely to fall from the surrounding vehicle to the vicinity of the host vehicle 1 exists.

At step S25, the second determination unit 3D determines that the object likely to fall from the surrounding vehicle to the vicinity of the host vehicle 1 does not exist.

### Fourth Embodiment

The host vehicle 1 to which the surrounding situation recognition device 16 of a fourth embodiment is applied is configured similarly to the host vehicle 1 to which the surrounding situation recognition device 16 of the first embodiment described above is applied, except that it will be described later.

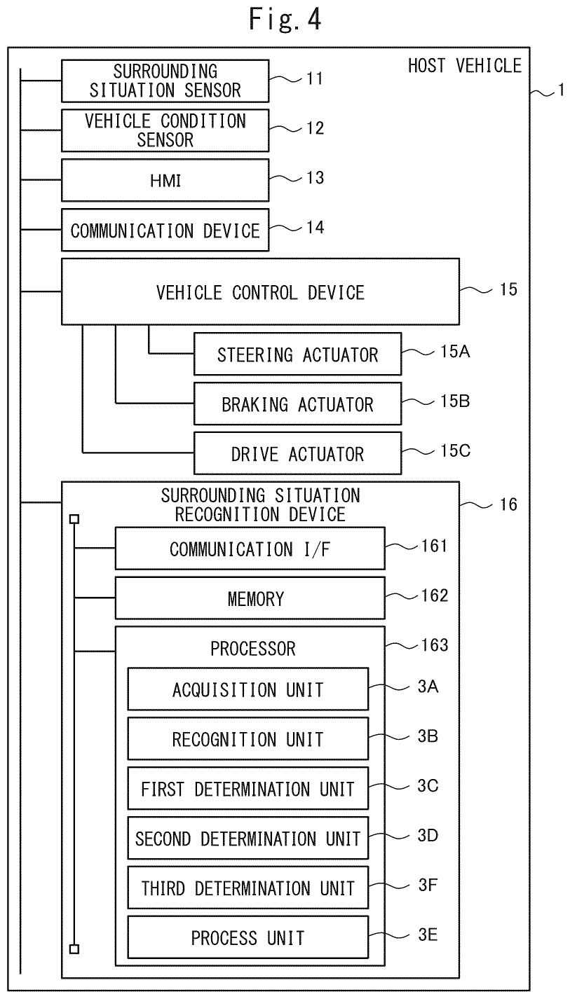

FIG. 4 is a view showing an example of the host vehicle 1 to which the surrounding situation recognition device 16 of the fourth embodiment is applied.

In the example shown in FIG. 4, the processor 163 has the function as the acquisition unit 3A, the function as the recognition unit 3B, the function as the first determination unit 3C, the function as the second determination unit 3D, the function as a third determination unit 3F, and the function as the process unit 3E.

The third determination unit 3F determines whether the object mounted on the surrounding vehicle is in a state where the object mounted on the surrounding vehicle can become the falling object.

For example, when the object mounted on the surrounding vehicle is in an overloaded state, the third determination unit 3F determines that the object mounted on the surrounding vehicle is in the state where the object mounted on the surrounding vehicle can become the falling object. Specifically, the third determination unit 3F determines whether the object mounted on the surrounding vehicle is in the overloaded state based on the measurement result of the surrounding state sensor 11 by using the model obtained by performing the learning using the teacher data which is the data set of, for example, the measurement result of the surrounding situation sensor mounted on the learning vehicle and the label indicating whether the object (learning object) mounted on the surrounding vehicle (learning surrounding vehicle) located in the vicinity of the learning vehicle is in the overloaded state wherein the vicinity of the learning vehicle is the measurement object of the surrounding situation sensor mounted on the learning vehicle.

In another example, when the object mounted on the surrounding vehicle is in a state where the object mounted on the surrounding vehicle is protruding from the surrounding vehicle, the third determination unit 3F may determine that the object mounted on the surrounding vehicle is in the state where the object mounted on the surrounding vehicle can become the falling object.

In yet another example, when the object mounted on the surrounding vehicle is in a state where the object mounted on the surrounding vehicle is mounted on the surrounding vehicle without being fixed to the surrounding vehicle, the third determination unit 3F may determine that the object mounted on the surrounding vehicle is in the state where the object mounted on the surrounding vehicle can become the falling object.

In the example shown in FIG. 4, when the first determination unit 3C determines that the object mounted on the surrounding vehicle corresponds to the specific object (object where the number of cases processed in the past as the falling object on the road is greater than or equal to the threshold value) and when the third determination unit 3F determines that the object mounted on the surrounding vehicle is in the state where the object mounted on the surrounding vehicle can become the falling object, the second determination unit 3D determines that the object likely to fall from the surrounding vehicle to the vicinity of the host vehicle 1 exists.

On the other hand, when the first determination unit 3C determines that the object mounted on the surrounding vehicle does not correspond to the specific object, the second determination unit 3D determines that the object likely to fall from the surrounding vehicle to the vicinity of the host vehicle 1 does not exist.

Further, when the third determination unit 3F determines that the object mounted on the surrounding vehicle is not in the state where the object mounted on the surrounding vehicle can become the falling object, the second determination unit 3D determines that the object likely to fall from the surrounding vehicle to the vicinity of the host vehicle 1 does not exist.

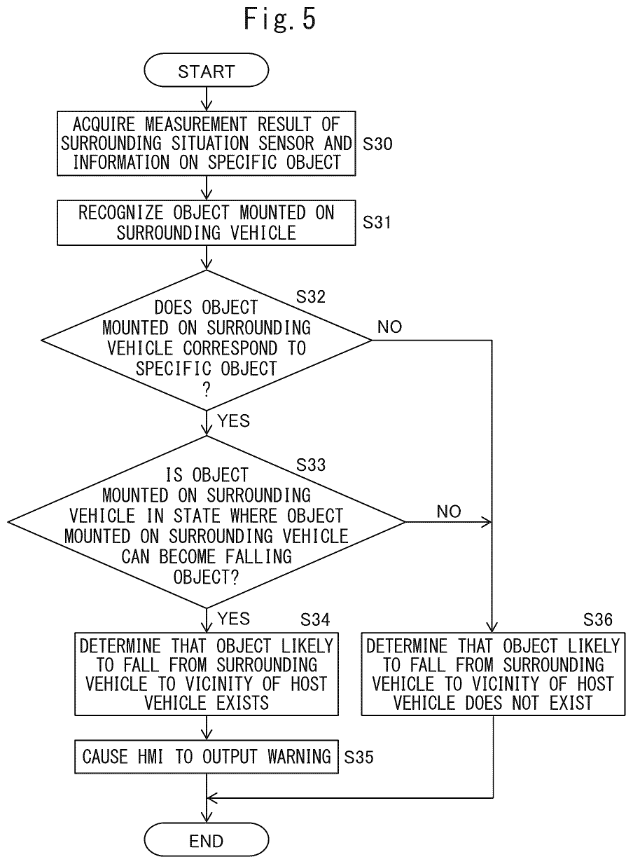

FIG. 5 is a flowchart for explaining an example of the process performed by the processor 163 of the surrounding situation recognition device 16 of the fourth embodiment.

In the example shown in FIG. 5, at step S30, the acquisition unit 3A acquires the measurement result of the surrounding situation sensor 11 from the surrounding situation sensor 11. The acquisition unit 3A acquires the information on the specific object from the memory 162.

At step S31, the recognition unit 3B recognizes the object mounted on the surrounding vehicle located in the vicinity of the host vehicle 1 based on the measurement result of the surrounding situation sensor 11 acquired at step S30.

At step S32, the first determination unit 3C determines whether the object mounted on the surrounding vehicle recognized at step S31 corresponds to the specific object (object where the number of cases processed in the past as the falling object on the road is greater than or equal to the threshold value) based on the information on the specific object acquired at step S30. When YES, it proceeds to step S33; when NO, it proceeds to step S36.

At step S33, the third determination unit 3F determines whether the object mounted on the surrounding vehicle is in the state where the object mounted on the surrounding vehicle can become the falling object. When YES, it proceeds to step S34; when NO, it proceeds to step S36.

At step S34, the second determination unit 3D determines that the object likely to fall from the surrounding vehicle to the vicinity of the host vehicle 1 exists.

At step S35, the process unit 3E performs the control for causing the HMI 13 to output the warning indicating that the object likely to fall from the surrounding vehicle to the vicinity of the host vehicle 1 exists.

At step S36, the second determination unit 3D determines that the object likely to fall from the surrounding vehicle to the vicinity of the host vehicle 1 does not exist.

As described above, although the embodiments of the surrounding situation recognition device, the surrounding situation recognition method, and the non-transitory recording medium of the present disclosure have been described with reference to the drawings, the surrounding situation recognition device, the surrounding situation recognition method, and the non-transitory recording medium of the present disclosure are not limited to the embodiments described above, and may be appropriately changed without departing from the scope of the present disclosure. The configuration of each example of the embodiment described above may be appropriately combined. In each example of the above-described embodiment, the process performed in the surrounding situation recognition device 16 has been described as software process performed by executing the program, but the process performed in the surrounding situation recognition device 16 may be process performed by hardware. Alternatively, the process performed by the surrounding situation recognition device 16 may be a combination of both software and hardware. Further, the program (program for realizing the function of the processor 163 of the surrounding situation recognition device 16) stored in the memory 162 of the surrounding situation recognition device 16 may be recorded in a computer-readable storage medium (non-transitory recording medium) such as, semiconductor memory, magnetic recording medium, optical recording medium, or the like for providing, distribution or the like.

1. A surrounding situation recognition device comprising a processor configured to:
determine whether an object mounted on a surrounding vehicle located in a vicinity of a host vehicle corresponds to a specific object which is an object where the number of cases processed in the past as a falling object on a road is greater than or equal to a threshold value; and
determine whether an object likely to fall from the surrounding vehicle to the vicinity of the host vehicle exists based on the result of determination whether the object mounted on the surrounding vehicle corresponds to the specific object.

2. The surrounding situation recognition device according to claim 1, wherein the processor is configured to determine whether the object mounted on the surrounding vehicle corresponds to the specific object which is the object where the number of cases processed in the past as the falling object on the road on which the host vehicle and the surrounding vehicle are currently traveling is greater than or equal to the threshold value.

3. The surrounding situation recognition device according to claim 1, wherein the processor is configured to
determine whether the object mounted on the surrounding vehicle is in a state where the object mounted on the surrounding vehicle can become the falling object, and
determine that the object likely to fall from the surrounding vehicle to the vicinity of the host vehicle exists when it is determined that the object mounted on the surrounding vehicle corresponds to the specific object and when it is determined that the object mounted on the surrounding vehicle is in the state where the object mounted on the surrounding vehicle can become the falling object.

4. A surrounding situation recognition method comprising:
determining whether an object mounted on a surrounding vehicle located in a vicinity of a host vehicle corresponds to a specific object which is an object where the number of cases processed in the past as a falling object on a road is greater than or equal to a threshold value; and
determining whether an object likely to fall from the surrounding vehicle to the vicinity of the host vehicle exists based on the result of determination whether the object mounted on the surrounding vehicle corresponds to the specific object.

5. A non-transitory recording medium having recorded thereon a computer program for causing a processor to perform a process comprising:
determining whether an object mounted on a surrounding vehicle located in a vicinity of a host vehicle corresponds to a specific object which is an object where the number of cases processed in the past as a falling object on a road is greater than or equal to a threshold value; and
determining whether an object likely to fall from the surrounding vehicle to the vicinity of the host vehicle exists based on the result of determination whether the object mounted on the surrounding vehicle corresponds to the specific object.
